(19) United States
(12) Patent Application Publication
(10) Pub. No.: US 2022/0145224 A1
(43) Pub. Date: May 12, 2022

(54) Spirit Obtainable From Wine And Comprising Taste- And Aroma Components Of The Wine, And Process For Its Production

(71) Applicants: Sándor Béla Doleschall, Telki (HU); Géza Pap, Budaors (HU)

(72) Inventors: Sándor Béla Doleschall, Telki (HU); Géza Pap, Budaors (HU)

(21) Appl. No.: 17/428,129

(22) PCT Filed: Feb. 3, 2020
(86) PCT No.: PCT/HU2020/000006

§ 371 Date: Aug. 3, 2021

(30) Foreign Application Priority Data
Feb. 4, 2019 (HU) P1900036

(51) Int. Cl. C12H 6/02; C12G 3/04; B01D 3/10; B01D 3/14; B01D 3/34

(52) U.S. Cl. CPC C12H 6/02; C12G 3/04; B01D 3/343; B01D 3/143; B01D 3/10

(57) ABSTRACT

The invention relates to a spirit produced exclusively from wine, the spirit containing 30-70% by volume of ethanol and having an extract content 0.5-5 times the extract content of the wine used for its production. The invention also relates to a process for producing a spirit that is produced exclusively from wine and contains 30-70% by volume of ethanol, the process comprising:
a) subjecting a wine to a vacuum distillation and obtaining a wine alcohol containing 35-85% by volume of ethanol, b) optionally continuing the vacuum distillation resulting in wine water as a distillate that does not contain ethanol or contains a negligible amount of ethanol, and in obtaining a wine concentrate as a distillation residue that does not contain ethanol or contains a negligible amount of ethanol, wherein, in the course of the vacuum distillation according to steps a) and
b), the temperature of the wine and the liquid that is formed therefrom during the vacuum distillation process and contains the extract content of the wine is maintained at 25° C. or below, and c) combining an amount of the wine alcohol with an amount of the wine concentrate and/or with an amount of the original wine and, optionally, with an amount of the wine water to obtain the spirit.

### TECHNICAL FIELD

The invention relates to a spirit obtainable from wine and containing exclusively the components of the wine used for its production, and also to a process for producing the spirit. The invention also relates to the uses of fractions obtainable from wine, i.e. wine alcohol, wine water or wine concentrate, for producing the spirit.

### BACKGROUND OF THE INVENTION

Alcoholic beverages are usually classified into the groups of beer, wine, and spirit.

Spirits are currently marketed worldwide, such drinks are, for example (the following list is non-exhaustive): armagnac, brandy (brandies), calvados, cognac, eau de vie, grappa, marc, palinka, rum, tequila, and vodka types, different whiskies (Scotch, single malt, blended, bourbon, rye, Irish) etc. Products made by adding additional ethanol are not classified here.

A common feature of commercially available spirits is that they are produced from some kind of low-alcohol content starting material (for example mash, beer, cider, wine) by means of heating, by distillation carried out at a temperature of 80° C. or higher. As a result of the technology used, the original aroma substances present in the starting materials are damaged to a great extent. The distillate obtained as an end product is usually subjected to a further treatment to provide the characteristic aroma and taste of the product. For example, white wine produced from specific grape vine varieties for producing cognac is distilled twice in spherical apparatuses, and the distillate thus obtained, which has an ethanol content of about 70% by volume, is aged in wooden barrels even for as long as several years, and during the ageing process the ethanol partially evaporates and the spirit gains its final ethanol content of about 40% by volume. The spirit is then stored and/or further aged in large bottles, and the commercially marketed brands are produced by finally blending the spirits of various ages. In the commercially marketed drink practically nothing is preserved from the aroma and taste of the original wine. The complete or near-complete lack of the original taste is in general a characteristic of almost all commercially available spirits. A further problem is that the ageing process requires a significant amount of capital investment.

The prior art contains no reference to a spirit that would contain the valuable (important) substances of wine.

### DESCRIPTION OF THE INVENTION

The object of the invention is to produce a spirit from wine that contains the valuable substances contained in the wine, while its extract content and thus its organoleptic properties can be controlled by the production process.

In theory, for producing such a spirit it would be sufficient to reduce the water content of the wine. It is, however, currently not feasible to directly remove water from the wine. Based on the partly theoretical and partly experimental analysis of the theoretically applicable methods we have recognised that by most of the known methods it is not possible to achieve our object at acceptable costs and at the desired quality. We have also recognised that—considering both technical and economical aspects—from the potentially applicable processes the most suitable one is vacuum distillation, carrying out which at a temperature of 25° C. or lower it is possible to fractionate the wine into characteristic fractions at the desired quality, and thus produce wine alcohol and wine water, and also wine concentrate that preserves the extract content of the wine. We have further determined the formulas (calculations) according to which the wine alcohol can be preferably combined, at respective appropriate ratios, with wine concentrate and/or with the original wine (i.e. another batch of the starting wine used for producing the fractions, or in another term, the “preserved wine”) and, optionally, with the wine water to provide such a spirit.

The objectives specified in relation to the invention are achieved by the products, processes and uses defined in the independent claims. Certain preferred embodiments of the invention are defined in the dependent claims.

### BRIEF DESCRIPTION OF THE DRAWING

FIG. 1 shows the conceptual scheme of an apparatus useful in the process according to the invention.

### MODES FOR CARRYING OUT THE INVENTION

The subject matter of the invention is therefore a spirit produced exclusively from wine, the spirit contains ethanol in a concentration of 30-70% by volume and has an extract content 0.5-5 times the extract content of the wine (the “original wine”) used for producing the spirit.

The phrase “produced exclusively from wine” is taken to mean that only wine is used as a starting material for producing the spirit according to the invention, the spirit is produced by combining fraction(s) obtained from the wine, and, optionally, the original wine.

The ethanol content of the spirit according to the invention is 30-70% by volume, preferably 38-55% by volume, most preferably 38-40% by volume.

The extract content of wines is customarily specified in g/l, the typical extract content of wines being 15-50 g/l, i.e. there is typically 15-50 g of extract substance in 1 l of wine. The extract content of the spirit according to the invention is preferably 0.5-5 times the extract content of the original wine (typically 7.5-25.0 g/l-75.0-250.0 g/l), preferably 0.9-5 times (typically 13.5-45.0 g/l-75.0-250.0 gift more preferably 0.9-4 times (typically 13.5-45.0 g/l-60.0-200.0 g/l) more preferably 0.9-3.5 times (typically 13.5-45.0 g/l-52.5-175 g/l) for example 2-4 times (typically 30.0-100.0 g/l-60.0-200.0 g/l) or for example 0.90-1.20-times thereof (typically 13.5-45.0 g/l-18.0-60.0 g/l).

The spirit according to the invention is obtainable by a process comprising the step of obtaining from a wine a wine alcohol, i.e. a 35-85% by volume aqueous solution of the wine's ethanol (i.e. ethanol deriving from the wine). For producing the spirit according to the invention, optionally a liquid—termed “a wine concentrate”—is obtained from the wine by reducing the original water content to the desired extent, said wine concentrate contains the extract content of the wine but contains no or a negligible amount (less than 0.5% by volume) of ethanol, and/or, optionally, wine water, which is a liquid with a very slight wine taste and aroma that contains no or a negligible amount of ethanol (less than 0.5% by volume) and no wine extract components, is also obtained from the wine, and an amount of the wine alcohol is combined with an amount of the wine concentrate and/or with an amount of the original wine and, optionally, with an amount of the wine water to obtain the spirit. The spirit according to the invention is preferably produced using vacuum distillation.

The invention therefore also relates to a process for producing a spirit that is produced exclusively from wine and contains 30-70% by volume of ethanol, the process comprising:

a) subjecting a wine to a vacuum distillation and obtaining, as a distillate, an alcoholic fraction containing about 35-85% by volume of ethanol (that is also termed wine alcohol or distillate),
b) optionally continuing the vacuum distillation resulting in an aqueous fraction as a distillate (that is also termed wine water) that does not contain ethanol or contains a negligible amount (i.e. in a concentration of less than 0.5% by volume) of ethanol, and in obtaining a distillation residue that is also termed wine concentrate and that does not contain ethanol or contains a negligible amount (i.e. in a concentration of less than 0.5% by volume) of ethanol,
wherein, in the course of the vacuum distillation according to steps a) and b), the temperature of the wine and the liquid that is formed therefrom during the vacuum distillation process and contains the extract content of the wine is maintained at 25° C. or below,
and wherein preferably a protective gas atmosphere is used for the vacuum distillation,
and wherein the wine alcohol obtained in step a) is optionally obtained by subjecting the alcoholic fraction obtained by a first vacuum distillation to a vacuum or atmospheric redistillation,
and
c) combining an amount of the wine alcohol with an amount of the wine concentrate and/or with an amount of the original wine and, optionally, with an amount of the wine water, wherein the amount of the wine alcohol used and the amount of the wine concentrate optionally used and the amount of the wine water optionally used for the combination are obtained by the distillation of one or more batches of the original (i.e. the starting) wine as carried out according to step a) and to the optionally performed step b).

A further aspect of the invention is a spirit with an ethanol content of 30-70% by volume, the spirit is obtainable by a process comprising:

a) subjecting a wine to a vacuum distillation and obtaining, as a distillate, an alcoholic fraction containing about 35-85% by volume of ethanol (that is also termed wine alcohol or distillate),
b) optionally continuing the vacuum distillation resulting in an aqueous fraction as a distillate (that is also termed wine water) that does not contain ethanol or contains a negligible amount (i.e. in a concentration of less than 0.5% by volume) of ethanol, and in a distillation residue that is also termed wine concentrate and that does not contain ethanol or contains a negligible amount (i.e. in a concentration of less than 0.5% by volume) of ethanol,
wherein, in the course of the vacuum distillation according to steps a) and b), the temperature of the wine and the liquid that is formed therefrom during the vacuum distillation process and contains the extract content of the wine is maintained at 25° C. or below,
and wherein preferably a protective gas atmosphere is used for the vacuum distillation process,
and wherein the alcoholic fraction obtained in step a) is optionally obtained by subjecting the alcoholic fraction obtained by a first vacuum distillation to a vacuum or atmospheric redistillation,
and
c) combining an amount of the wine alcohol with an amount of the wine concentrate and/or with an amount of the original wine and, optionally, with an amount of the wine water, wherein the amount of the wine alcohol used and the amount of the wine concentrate optionally used and the amount of the wine water optionally used for the combination are obtained by the distillation of one or more batches of the original wine (i.e. the same wine) as carried out according to step a) and to the optionally performed step b).

The invention also relates to the use of a wine alcohol for producing a spirit with an ethanol content of 30-70% by volume, the wine alcohol contains 35-85% by volume of ethanol and is obtainable by a vacuum distillation of a wine, wherein, in the course of the vacuum distillation, the temperature of the wine and the liquid that is formed therefrom during the vacuum distillation process and contains the extract content of the wine is maintained at 25° C. or below, and wherein preferably a protective gas atmosphere is used for the vacuum distillation process.

The invention also relates to the use of a wine concentrate for producing a spirit with an ethanol content of 30-70% by volume, the wine concentrate being obtainable as a distillation residue of a vacuum distillation of a wine, in the course of which the temperature of the wine and the liquid that is formed therefrom during the vacuum distillation process and contains the extract content of the wine is maintained at 25° C. or below, and wherein preferably a protective gas atmosphere is used for the vacuum distillation process.

The invention further relates to the use of wine water for producing a spirit with an ethanol content of 30-70% by volume, the wine water being obtainable as an aqueous fraction of a fractional vacuum distillation of a wine, wherein the temperature of the wine and the liquid that is formed therefrom during the distillation process and contains the extract content of the wine is maintained at 25° C. or below, and wherein preferably a protective gas atmosphere is used for the vacuum distillation process.

According to certain embodiments, the volume of the wine concentrate is at most 1/7.5 times the original volume of the wine used for its production (i.e. about 13.3% of the wine used), for example ½-⅙ times the original volume of the wine, for example ⅓ times.

According to certain embodiments of the processes according to the invention, vacuum distillation(s) is/are carried out at a collector temperature of (−5)-(+3) ° C.

The pressure used in step a) of the above described process is adjusted by gradually decreasing it to a value at which the wine starts boiling. After the near-complete removal of alcohol, boiling stops. Then, in order to adjust the pressure used in step b) of the process, pressure has to be reduced relative to step a), until boiling begins again. Step a) is typically carried out at a pressure of 20-25 mbar, while step b) is typically performed at a pressure of 12-20 mbar.

According to the invention, the above mentioned fractions can be produced from the wine in a way that the quality of the wine's components does not change or it changes only to a minimal extent.

In the process according to the invention, therefore, the following fractions can be obtained from the wine:
Alcoholic fraction (throughout the present specification it is also referred to as “wine alcohol” or “distillate”), i.e. the 35-85% by volume aqueous solution of the ethanol of the wine. The ethanol content of the alcoholic fraction (wine alcohol) can be increased by a further (separate) distillation, in which case this aqueous solution having an increased ethanol content will be the alcoholic fraction (i.e. the wine alcohol). For example, if a wine alcohol of 33% by volume ethanol concentration is obtained by the first vacuum distillation of the wine, then the wine alcohol has to be distilled once again.
Aqueous fraction (throughout the present specification it is also referred to as “wine water”), which optionally also can be used for producing the spirit according to the invention. Wine water is a liquid with a very slight wine taste and aroma that is obtained during distillation of the wine carried on after obtaining the alcoholic fraction, and contains no or a negligible amount of ethanol (i.e. less than 0.5% by volume) and no wine extract components.
Wine concentrate, i.e. the bottoms remaining in the vessel, i.e. a liquid obtained from the original wine by reducing the original water content to the desired extent that contains the extract content of the original wine and contains no or a negligible amount (i.e. less than 0.5% by volume) of ethanol (by way of example, the volume of the wine concentrate is ½-1/7.5 of the original volume of the wine). The concentrate preserves the entirety of the extract content of the original wine at a higher concentration, but the ratio of the components making up the extract content is essentially unchanged as compared to the original wine. (For example, the sugar-free extract content of wines is typically 15-50 g/l; so in case reduction to half the original volume is used, this value will be 30-100 g/l in the wine concentrate.)

For producing the spirits according to the invention it is expedient that the ethanol content of the wine alcohol is high, because the aim is to remove water. For example, in one litre of a wine with 10% by volume of alcohol content there is 0.1 litre of ethanol and 0.9 litre of aqueous solution. 0.75 litre of water is to be removed from the wine to have 0.25 litre of a spirit remained that has an ethanol content of 40% by volume and an extract content that is four times the extract content of the original wine.

The alcoholic fraction with an ethanol content of 35-85% by volume is obtained, optionally by redistillation, after obtaining and discarding, at the beginning of the vacuum distillation process, an initial distillate (in the following: forerun, having a quantity that is typically 0.5-3% of the volume of the original wine) that contains undesired substances.

The alcoholic fraction contains 35-85% by volume, preferably 55-85% by volume, of ethanol.

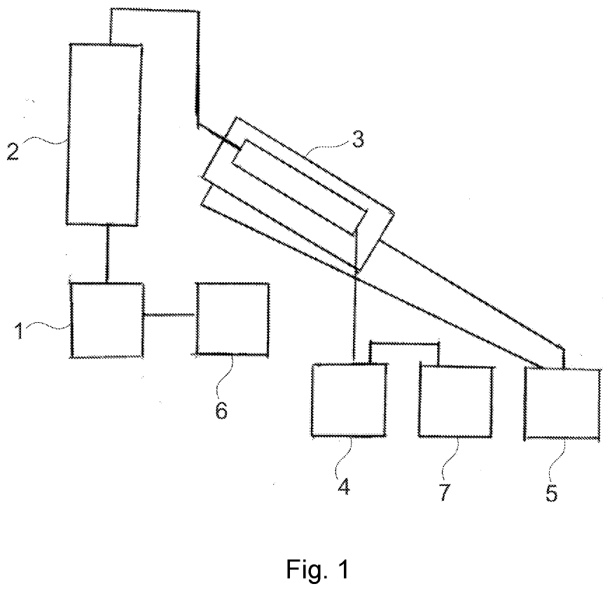

Vacuum distillation is preferably performed using an apparatus assembled according to the schematic configuration depicted in FIG. 1. The typical process of vacuum distillation is summarized in the following using the references used in the FIGURE.

The apparatus comprises an 1 adjustable-temperature container (vessel) for receiving the starting base material, a 2 packed column, a 3 unit for cooling the distillate, a 4 collector for the distillate, a 5 coolant container with a circulation pump, a 6 container for the optionally used protective gas (nitrogen, carbon dioxide), and a 7 vacuum pump.

Wine is fed to the 1 vessel followed by generating a vacuum in the system. Distillation of the wine is thereby begins. Vapour-state components are condensed using the 2 packed column and the 3 cooling unit, and the cooled-down (and therefore, again liquid) distillate is collected in the 4 container. The required vacuum is generated by the 7 vacuum pump. In the first step, typically at a pressure of about 20-25 mbar, the ethanol content of the wine is removed.

After removing the alcoholic fraction, distillation is continued at a reduced vacuum pressure (about 12-20 mbar) until the desired quantity (for example, ½-1/7.5 of the volume of the wine fed to the vessel) of wine concentrate, or “aroma concentrate” containing the original extract content—a usually darker-colour, sour-tasting liquid—remains in the vessel. The optionally used protective gas can be provided from the 6 container. Wine water can be obtained during this step.

The result of the process according to the invention is therefore a spirit that preserves the characteristics of the starting wine base material but at the same time has an ethanol content of 30-70% by volume. Therefore, it is especially worthwhile to use this process for such starting base materials that have appropriate enjoyment value, i.e. for example grape wines, apple wine, fruit wine, i.e. in such cases where the enjoyment value is worth preserving.

A valuable characteristic of red wines is that—compared to other natural materials—they contain relatively large amounts of substances that have medically proven beneficial physiological effects on human health. Such active substances include: leucoanthocyanins, catechins, anthocyanins, t-resveratrol (transresveratrol), quercetin and E-viniferin, other polyphenols.

In our studies, we have found that the especially valuable components of red wines (for example: leucoanthocyanin, catechin, anthocyanin, t-resveratrol (transresveratrol), quercetin and E-viniferin, other polyphenols) are entirely preserved in the wine concentrate in their original form when using the process according to the invention, because according to our measurements they are not contained either in the wine alcohol or in the wine water.

Our studies have shown that the above listed substances are contained in the wine concentrate in unchanged quality, at an amount that is nearly the same as the quantity contained by the original red wine, but at a much higher concentration, in a concentration that—depending on the concentration rate—is even by orders of magnitude higher than what is found in other sources (for example, blueberries, sloes, Japanese root). These substances, optionally even in greater concentrations, are also present in the spirits according to the present invention, enhancing their value: according to the invention, such a spirit is produced that is not only tasty, but also contains substances that help to maintain health.

The spirit according to the invention contains the components of the original wine (i.e. the wine used for its production) and only the components of the original wine. In the process according to the invention, exclusively physical methods are used. The products obtained using the process contain only the original components of the wine present at the beginning of the distillation process. The concentration of the components can be smaller or greater as compared to the original wine, but the relative ratios of the components making up the extract content is essentially unchanged.

Using the process according to the invention, therefore, a spirit can be obtained that retains to a good approximation the original taste of the wine, with a wine concentrate containing valuable substances—in the case of red wines especially valuable substances—also being available.

According to the invention, therefore, a spirit containing valuable components making up the original extract content of the wine can be produced from wine. As a result of the process, the aroma and taste components and the extract content are preferably—based on organoleptic evaluation, nearly as unaltered—preserved in the wine concentrate.

In the batch-type implementation of the process according to the invention, the quantity of wine that can be processed in a single run is limited by the size of the distillation vessel. When processing quantities greater than that, the process has to be repeated using another batch of wine. It is important that the entire quantity of wine to be processed should be the same original wine. The wine alcohol, wine water, and wine concentrate obtained in subsequent respective processing steps are stored separately, but preferably in respective common containers for each constituent (i.e. wine alcohol, wine concentrate, and wine water), i.e. preferably the matching fractions are combined (wine alcohol fractions are combined with each other, wine water fractions are combined with each other, and wine concentrate fractions are combined with each other). This implies that a particular used quantity of a given constituent (for example, wine alcohol) can originate from the distillation of two or more batches of the original wine. Furthermore, the disclosure “the amount of the wine alcohol used and the amount of the wine concentrate optionally used and the amount of the wine water optionally used for the combination are obtained by the distillation of one or more batches of the original wine (i.e. the same wine) as carried out according to step a) and to the optionally performed step b)”, also covers embodiments according to which the fraction(s) (wine alcohol and optionally wine concentrate and optionally wine water) used for producing the spirit originate from distillations of different batches of wine.

The “combination step” of the production process of the spirits according to the invention is basically affected by two factors: the degree of alcohol to be reached, and the provision of a composition that approaches the original taste, aroma, and bouquet of the wine. The ethanol level is adjusted based on the ethanol content of the constituents to be blended, on the basis of the ethanol balance. This can be accurately quantified. The characteristics of the wine can be adjusted by adding wine concentrate and/or original wine and/or wine water, based on organoleptic evaluation and on adjusting the extract content.

For producing the spirit according to the invention, for example the following two methods can be used. In the case of the first method, the original wine is available (in the required amount), and the wine alcohol obtained, and, optionally, the wine water and the wine concentrate obtained, also being available for use if required. In the case of the second method, the original wine is not available or it is not intended to be used. The first method is more preferable because the amount of original wine that is introduced into the spirit contributes to increasing the quantity of aroma and taste substances in the spirit, while the yield of the spirit is also higher. During the production of the spirit it is assured that the extract content of the spirit preferably approaches or exceeds the extract content of the starting wine.

In the case of the first method, for example the following options are available:
1.) Based on the ethanol balance, such an amount of original wine is added to the entire quantity of the available wine alcohol, that an ethanol-containing spirit with the desired ethanol content is produced. In the case of such a technical solution, the extract content of the spirit will be lower than that of the original wine.
2.) Such an amount of the wine concentrate is added to the original wine that the desired extract content of the spirit can be achieved after adding the wine alcohol later on. Then we proceed according to the previous option, except that a version of the original wine that is enriched by wine concentrate is used instead of the original wine.
3.) Such an amount of original wine is added to the entire quantity of the wine alcohol available that the ethanol content is about 1-4% by volume higher than the ethanol content of the targeted (desired) spirit. This is followed by adding, calculated from the ethanol balance, an amount of the available wine concentrate and/or wine water, thus adjusting the extract content (and thereby the organoleptic properties) of the spirit.

In the case of the second method a possible option is as follows:
As a first step, the degree of concentration of the wine concentrate is selected: the greater the degree of concentration, the higher the need to use wine water for adjusting the organoleptic properties of the spirit. Then, the entire available quantity of the wine alcohol is combined with such an amount of wine concentrate and optionally wine water that the desired ethanol content (in percent by volume) can be adjusted according to the ethanol balance and also the desired organoleptic properties can be adjusted.

The use of a maximum temperature of 25° C., and the optional use of a protective gas, i.e. carrying out the process according to the invention preferably under the protection of a protective gas (for example, nitrogen or carbon dioxide) to prevent oxidative processes ensure that no chemical conversions occur in the wine.

In the following discussion, some rules and options applicable for producing the spirit from the available constituents will be specified:

Symbols:
B: Quantity of the starting wine subjected to distillation (i.e. vacuum distillation), from which the wine alcohol and the concentrate (and the wine water) are produced, litre
BAF: Percentage of alcohol by volume of the wine
BT: Quantity of the reserved portion of the starting wine that is used for producing the spirit, litre
BTO Total amount of wine used, litre
BEX: Extract content of the wine, g/litre
S: Quantity of the concentrate obtained by the distillation, litre
SI: Quantity of the concentrate used for producing the spirit, litre
SF: Degree of concentration, i.e. the reciprocal of the value obtained by dividing the amount of the concentrate by the amount of the starting wine; specifies the degree by which the starting wine is concentrated, a number
SEX: Extract content of the concentrate, g/litre
P^{e}: Amount of wine alcohol that can be theoretically obtained from the wine “B”, litre
PVE: Loss of wine alcohol, percent
P: Amount of wine alcohol that can be actually used, litre
PAF: Percentage of alcohol by volume of the wine alcohol
WVE: Loss of water during the concentration process, percent
WL: Amount of wine water actually available
ITAL: Amount of the spirit (the final product), litre
IAF: Degree of alcohol of the spirit, percent
IEX: Extract content of the spirit, g/litre
HAT: Efficacy of the spirit production process, percent

Basic Relations:

BTO=B+BT

S=B/SF

P^{e}=B×BAF/PAF

P=P^{e}×(100−PVE)/100

SEX=BEX×SF

IEX=BEX×(SI×SF+BT)/ITAL

HAT=100×ITAL/BTO

PAF>IAF

A necessary condition for producing the spirit in an economical manner is that the total amount of wine alcohol obtained from the wine is used for producing the spirit.

The spirit is obtainable by using the preserved portion of the starting wine (“BT”), the concentrate (“SI”), and the wine alcohol (“P”). For practical reasons, the wine water (“WL”) is not used in the present discussion (unnecessary dilution, reducing SF is also a solution which also reduces costs).

The basis of the calculation is the ethanol balance:

IAF×(P+BT+SI)=P×PAF+BT×BAF (wherein P^{e}=B×BAF/PAF and P=P^{e}×(100−PVE)/100).

The known values are:

B, BAF, PAF, PVE, SF, WVE, IAF, therefore there are two unknown parameters in the ethanol balance: “BT” and “SI”. The value of one of these parameters is chosen (specified), and then the value of the other parameter is calculated.

We have recognised that, to provide a characteristic “wine taste” and “wine aroma” for the spirit it is preferable if the extract content of the spirit approaches or exceeds the extract content of the starting wine. The “SI” value that provides that the extract content of the spirit is equal to the extract content of the starting wine is determined by the following formula:

SI_{BEX}=P/(SF−1)

We have recognised that there is also an upper limit for SI:

SIMAX=P×(PAF−IAF)/IAF

if “SI” exceeds this value and “BT” is calculated using this “SI” value, it will be a negative number; in such a case—and/or if SI_{BEX}>SI_{MAX}—the desired spirit cannot be produced with the given “SF” and “PAF” values, and the manufacturing technology has to be modified, i.e. the value of “SF” and/or of “PAF” has to be increased.

According to the above, thus, for producing the spirit one of the values “BT” and “SI” is first chosen (fixed), which is followed by determining the other value. After that, the quantity of the spirit (“ITAL”) can already be calculated.

There are two special cases:
1. We intend to produce the spirit without using the starting wine. In this case, BT=0.
   The quantity of the concentrate to be used in such a case is:

SI=P×(PAF−IAF)/IAF

ITAL=P+SI

IEX=BEX×SI×SF/ITAL
2. We do not intend to use any concentrate for producing the spirit. In this case, SI=0.
   The quantity of the starting wine to be used in such a case is:

BT=P×(PAF−IAF)/(IAF−BAF)

ITAL=BT+P

IEX=BEX×BT/ITAL

In a generic case, both BT and SI are greater than zero (BT>0 and SI>0). In such a case, the following process is used:
a.) In the first subcase, the value of “BT” is chosen.
   For “BT” such a value has to be chosen that the condition
   BT<=P×(PAF−IAF)/(IAF−BAF) holds true (this condition ensures that SI will not be negative),
   with the given value of “BT” the value of “SI” is calculated as follows:

SI=[P×(PAF−IAF)−BT×(IAF−BAF)]/IAF (1)
If the desired extract content of the spirit to be produced according to the invention is about the same as (or greater than) the extract content of the original wine, but the value of “SI” defined by the formula (1) is smaller than “SI_{BEX}”, then the value of “BT” is modified (reduced) so as to achieve that the extract content of the spirit reaches or exceeds the extract content of the starting wine.
b.) In the second subcase, the value of “SI” is chosen, and the value of “BT” is calculated based on that “SI” value. For choosing SI, it is expedient to start from the value SI=SI_{BEX}. By gradually increasing the value of “SI” up to SI=SI_{MAX}, the extract content of the spirit will also increase, while the organoleptic properties thereof will also change. The SI value chosen has to fulfill the following two conditions:

SI<=S and SI<=SI_{MAX}
The value of BT is then calculated using the SI value chosen according to the above conditions:

BT=[P×(PAF−IAF)−SI×IAF]/(IAF−BAF) (2)
It is also possible to further increase the extract content: the degree of concentration “SF” has to be increased.
Knowing “BT” and “SI”, the other characteristic parameters of the production process of the spirit can be calculated:
Quantity of the spirit:

ITAL=BT+P+SI
Extract content of the spirit:

IEX=BEX×(SF×SI+BT)/ITAL
Total quantity of the wine used:

BTO=B+BT
Further generic relations:
Unused concentrate:

SR=S−SI
Wine water produced during the production process:

(WSL)^{e}=B−P^{e}−S

WL=(WSL)^{e}×(100−WVE)/100
Yield of the process relative to the wine:

HAT=100×ITAL/BTO

In the case of known spirits (for example, brandy, cognac, whisky) the ageing process requires a significant amount of capital investment; in comparison to that the production process of the spirit made from wine according to the invention is significantly more economical.

### EXAMPLES

### Example 1

4500 ml of room-temperature (about 20-22° C.) wine was fed into a vessel of a volume of 6 l, and was subjected to vacuum distillation. Pressure was reduced until boiling started (this occurred between 20 and 25 mbar); the process was then continued at this pressure. Then, after taking and discarding 90 ml of forerun (the first 3-10% by volume of the wine alcohol, which is characterised by foul taste and aroma, and may also contain harmful substances that very adversely affect the quality of the end product), about 750 ml of wine alcohol with an ethanol content of 35% by volume was obtained. After taking the wine alcohol fraction, boiling stopped, while the pressure was reduced further to remove water. Boiling started at a pressure of 12-20 mbar, with the distillation process being continued at this pressure range, until 750 ml of concentrate (wine concentrate) remained in the vessel. This was a sour-tasting liquid with a darker colour compared to the original starting material. The wine water of a volume of about 2700 ml and of a very low ethanol content (lower than 0.3% by volume) that was obtained during producing the wine concentrate after having taken the wine alcohol was a substance with very mild aroma and taste. The wine alcohol was redistilled, and, after taking and discarding about 30 ml of forerun, about 320 ml of a liquid with an ethanol content of 60% by volume, i.e., the alcoholic fraction (wine alcohol) was obtained. It was ensured during the entire process that the temperature of the wine and the wine concentrate remained under 25° C.

### Example 2

About 100 ml of a spirit having an alcohol content of about 40% by volume and to a sufficient approximation the taste and aroma of the original wine was produced from the constituents obtained according to Example 1, by mixing 66 ml of wine alcohol with an ethanol content of 60% by volume, 16-17 ml of wine concentrate distilled to a volume that is ⅙ times the original volume of the wine, and 17-18 ml of wine water. The extract content of the spirit was about 0.96-1.02 times the extract content of the original wine.

### Example 3

The process of Example 2 was followed, except that instead of wine water original wine was used. To 100 ml of wine having an ethanol content of 12% by volume 165 ml of wine alcohol was added that was obtained from the same wine and had an ethanol content of 60% by volume, and 10 ml of wine concentrate distilled to a volume that is ⅙ times the original volume. Thereby, 275 ml of a spirit with an ethanol content of 40% by volume was obtained. The extract content of the spirit was about 0.58 times the extract content of the original wine.

### Example 4

a) 1 litre of wine alcohol of a concentration of 75% by volume was taken from the available constituents.

The ethanol content of the required spirit was 40% by volume. For producing the desired spirit, 1.207 litres of the original wine having an ethanol content of 11% by volume was required, i.e. after adding the 1.207 litres of original wine to 1 litre of wine alcohol, 2.207 litres of spirit with an ethanol content of 40% by volume was obtained. The extract content of the spirit was 1.207/2.207=54.7% of the extract content of the wine.

b) A spirit was produced using wine alcohol, wine concentrate and the original wine as follows:

1 litre of wine alcohol with an ethanol content of 75% by volume was provided. The ethanol content of the original wine was 11% by volume. 1.065 litres of the original wine was taken and added to the 1 litre of wine alcohol, and then 0.103 litre of wine concentrate was added to obtain 2.168 litres of a spirit with an ethanol content of 40% by volume. The extract content of the spirit was dependent on the degree of concentration of the wine concentrate (given below as a percentage of the extract content of the original wine):

| | Extract content relative |
|---|---|
| Concentration | to the original wine |
| 2-fold | 58.6% |
| 3-fold | 63.4% |
| 4-fold | 68.1% |
| 5-fold | 72.9% |
| 6-fold | 77.6% |
| 7-fold | 82.4% |

### Example 5

a) 1 litre of wine alcohol with an ethanol content of 75% by volume was provided.

The ethanol content of the required spirit was 40% by volume. This ethanol content was reached by the addition of wine concentrate: by adding 0.875 litre of wine concentrate to 1 litre of wine alcohol, 1.875 litres of a spirit with an ethanol content of 40% by volume was obtained.

The extract content of the spirit thus obtained was dependent on the degree of concentration of the wine concentrate.

b) The vacuum distillation process of the invention was used to obtain wine alcohol, wine concentrate, and wine water. A spirit was produced using these as follows:

1 litre of wine alcohol with an ethanol content of 75% by volume was provided. The targeted ethanol content of the spirit was 40% by volume. The amount of wine concentrate used was 0.92465 litre, and as a result, the amount of the spirit having an ethanol content of 40% by volume was 1.925 litres.

The extract content of the spirit was dependent on the degree of concentration of the wine concentrate used. The extract content of the spirit, given as a percentage of the extract content of the original wine is listed below as a function of the wine concentrate:

Concentration

| | |
|---|---|
| 2-fold | 96% |
| 3-fold | 144% |
| 4-fold | 192% |
| 5-fold | 240% |
| 6-fold | 288% |
| 7-fold | 336% |

### Example 6

6 litres of commercially available Villányi Cabernet Sauvignon were divided into 4 batches and subjected to fractional vacuum distillation as follows: 1 batch of wine of a temperature of 24° C. was fed into the vessel. The wine started boiling at a pressure of 22-23 mbar. After the removal of wine alcohol, boiling stopped, so system pressure was reduced until the liquid in the vessel started boiling again. This occurred at a pressure of 14-15 mbar. Removal of the wine water was continued until 0.25 l of concentrate was left in the vessel. The concentrate, the wine alcohol, and the wine water were stored in 3 separate containers. The process was carried out again using 3 further batches of wine. The concentrates (0.25 litre each) obtained from the other 3 batches of wine were added to the first 0.25 litre of concentrate, while the wine alcohols and the wine waters were added to the wine alcohol and the wine water, respectively, each obtained by processing the first batch of wine and stored in the respective container. Thereby, 1 litre of six-fold concentrated wine concentrate, and also wine alcohol and wine water were obtained. Tests performed on the wine concentrate gave the following results:

Total polyphenol: 14.368 mg/l
Total oxidant capacity: 272.6
Leucoanthocyanins: 11440 mg/l
Catechins: 5754 mg/l
Anthocyanins: 1.175 mg/l
Transresveratrol: 18 mg/l
E-viniferin: 25 mg/l
Quercetin: 97.8 mg/l.

The quantities of the above substances in the wine water and in the wine alcohol were 0.0 mg/l.

The ref % value of the wine distilled to a volume that is ⅙ times the original volume was 18.8, which means that 188 g of “powder” is obtained from 1 litre of wine concentrate. Calculated back to the original wine, the wine volume yielding the 188 g of dry matter is 6 litres.

### Examples 7-8

For the processes and products described in Examples 7 and 8 below, the distillation of the invention was carried out using a greater quantity of a wine with an ethanol content of 11% by volume and an extract content of 20 g/l (BAF=11, BEX=20); the wine concentrate and the distillates (the wine alcohol and the wine water) were stored in 3 different containers. The PVE value (i.e. loss of wine alcohol) characteristic for the distillation process was 3%. The ethanol content of the wine alcohol (PAF) was 75% by volume, the volume of the wine concentrate being one-sixth of the volume of the wine subjected to distillation, i.e. the degree of concentration was SF=6. Therefore, the available constituents were: wine concentrate, wine water, and wine alcohol, while the original wine was also available (“available constituents”). These constituents were used for carrying out the processes and providing the products described in the following examples, using the calculations described above, i.e. the formulas specified above that are repeated in the examples to the extent necessary.

### Example 7

A spirit according to the invention with an alcohol content of 40% by volume is produced from 10 litres of wine having an extract content of 20 g/l as follows:

Initial parameters:

### B=10

### BAF=11

### PAF=75

### PVE=3

### SF=6

### BEX=20

### IAF=40

### S=1.67

Under the condition BEX=IEX (BEX=20 and IEX=20), the following calculations were performed:

P^{e}=B×BAF/PAF=1.47

P=P^{e}×(100−PVE)/100=1.42

If BEX=IEX, then SI=SI_{BEX}, so SI=P/(SF−1)=0.29

BT=[P×(PAF−IAF)−SI×IAF]/(IAF−BAF)=1.33

Then the yield was calculated:

BTO=B+BT=11.33

ITAL=BT+P+SI=3.03

HAT=100×ITAL/BTO=26.77%

Based on the calculations, therefore, 3.03 l of spirit having an extract content of 20 g/l and an ethanol content of 40% by volume is produced using 1.42 l of wine alcohol, 0.29 l of concentrate, and 1.33 l of the reserved portion of the wine. The extract content of the spirit was about 100% of the extract content of the original wine (i.e. the extract content of the spirit is 1 time the extract content of the starting wine).

The yield relative to the wine used: 26.77%.

### Example 8

Unlike in the previous example, in this example the aim is to produce a spirit that has the maximum extract content attainable with the extract content of the original wine, with SF=6 (spirit “a”), and also a spirit that has 10% lower extract content (spirit “b”). This can be achieved by modifying the amount of wine concentrate added to the spirit. The degree to which the “SI” value has to be modified cannot be determined directly, but by modifying the “SI” value while adhering to the conditions specified above the quantity that yields the desired results can be readily determined. Such a change also affects the organoleptic properties of the spirit.

Taking into account the above considerations, spirits according to the invention with an alcohol content of 40% by volume are produced from 10 litres of wine having an extract content of 20 g/l as follows. The values of SI_{BEX} and SI_{MAX} are calculated as put forward above:

SI_{BEX}=P/(SF−1)=0.29

SI_{MAX}=P×(PAF−IAF)/IAF=1.25

### Initial Parameters for Examples 8a) and 8b)

### B=10

### BAF=11

### PAF=75

### PVE=3

### SF=6

### BEX=20

### IAF=40

### S=1.67

a) For producing a spirit with the highest attainable extract content (i.e. under the condition IEX=maximum) the following calculations were performed. The condition necessary for achieving the maximum value: BT=0. Then

P^{e}=B×BAF/PAF=1.47

P=P^{e}×(100−PVE)/100=1.42

SI=P×(PAF−IAF)/IAF=1.25

Then the yield was calculated:

BTO=B+BT=10

ITAL=BT+P+SI=2.67

HAT=100×ITAL/BTO=26.7%

IEX=BEX×(SF×SI+BT)/ITAL=56.18

Based on the calculations, therefore, 2.67 l of a spirit with an extract content of 56.18 g/l and with ethanol content of 40% by volume is produced using 1.42 l of wine alcohol and 1.25 l of concentrate. The extract content of the spirit is about 2.8 times the extract content of the original wine.

The yield relative to the wine used: 26.7%.

b) For producing the spirit, the following calculations were performed with the aim IEX=0.9×BEX:

P^{e}=B×BAF/PAF=1.47

P=P^{e}×(100−PVE)/100=1.42

Under the condition IEX=0.9×BEX, a series of calculations result in the following:

SI=0.23

BT=1.41

Then the yield was calculated:

BTO=B+BT=11.41

ITAL=BT+P+SI=3.05

HAT=100×ITAL/BTO=26.78%

Based on the calculations, 3.05 l of spirit having an extract content of 18.08 g/l and an ethanol content of 40% by volume is produced using 1.42 l of wine alcohol, 0.23 l of concentrate, and 1.41 l of the reserved portion of the wine. The extract content of the spirit was about 90% of the extract content of the original wine.

The yield relative to the wine used: 26.78%.

If an “IEX” value is desired that is higher than the value achieved with the spirit “a)” of Example 8 at the maximum extract content (IEX=56.18, i.e. a rise of 180%), then the value of “SF” has to be increased. The value SF=7 is chosen.

### Initial Parameters for Examples 8c) and 8d):

### B=10

### BAF=11

### PAF=75

### PVE=3

### SF=7

### BEX=20

### IAF=40

### S=1.43

c) For producing the spirit, the following calculations were performed under the condition IEX=maximum:

In case IEX=maximum

BT=0.0

P^{e}=B×BAF/PAF=1.47

P=P^{e}×(100−PVE)/100=1.42

SI=P×(PAF−IAF)/IAF=1.25

Then the yield was calculated:

BTO=B+BT=10

ITAL=BT+P+SI=2,67

HAT=100×ITAL/BTO=26.68%

IEX=BEX×(SF×SI+BT)/ITAL=65.33

Based on the calculations, therefore, 2.67 l of a spirit with an extract content of 65.33 g/l and with an ethanol content of 40% by volume is produced using 1.42 l of wine alcohol and 1.25 l of concentrate. The extract content of the spirit is about 3.27 times the extract content of the original wine.

The yield relative to the wine used: 26.68%.

d) For producing the spirit, the following calculations were performed—using the initial parameters—under the condition IEX=BEX (BEX=20 and IEX=20):

P^{e}=B×BAF/PAF=1.47

P=P^{e}×(100−PVE)/100=1.42

As BEX=IEX, SI=P/(SF−1)=0.24

BT=[P×(PAF−IAF)−SI×IAF]/(IAF−BAF)=1.39

Then the yield was calculated:

BTO=B+BT=11.39

ITAL=BT+P+SI=3.05

HAT=100×ITAL/BTO=26.78%

Based on the calculations, therefore, 3.05 l of spirit having an extract content of 20 g/l and an ethanol content of 40% by volume was produced using 1.42 l of wine alcohol, 0.24 l of concentrate, and 1.39 l of the reserved portion of the wine. The extract content of the spirit was about 100% of the extract content of the original wine.

The yield relative to the wine used: 26.78%.

### Example 9

Spirits according to the invention with an alcohol content of 40% by volume are produced from 10 litres of wine having an extract content of 20 g/l, without using a concentrate (SI=0), as follows:

### Initial Parameters for Examples 9a) and 9b):

### B=10

### BAF=11

### PVE=3

The value of SF is selected arbitrarily from the feasible range

### BEX=20

### IAF=40

### SI=0

a) For producing the spirit, the following calculations were performed using the above initial parameters, with value PAF=70:

P^{e}=B×BAF/PAF=1.57

P=P^{e}×(100−PVE)/100=1.52

BT=P×(PAF−IAF)/(IAF−BAF)=1.58

Then the yield and the extract content were calculated:

BTO=B+BT=11.58

ITAL=BT+P+SI=3.10

HAT=100×ITAL/BTO=26.7%

IEX=BEX×(SI×SF+BT)/ITAL=10.17

Based on the calculations, 3.10 l of spirit having an extract content of 10.17 g/l and an ethanol content of 40% by volume is produced using 1.52 l of wine alcohol, and 1.58 l of the reserved portion of the wine. The extract content of the spirit was about 0.51 times the extract content of the original wine.

The yield relative to the wine used: 26.76%.

b) For producing the spirit, the following calculations were performed using the above initial parameters, with value PAF=80:

P^{e}=B×BAF/PAF=1.38

P=P^{e}×(100−PVE)/100=1.33

BT=P×(PAF−IAF)/(IAF−BAF)=1.84

Then the yield and the extract content were calculated:

BTO=B+BT=11.84

ITAL=BT+P+SI=3.17

HAT=100×ITAL/BTO=26.80%

IEX=BEX×(SI×SF+BT)/ITAL=11.59

Based on the calculations, 3.17 l of spirit having an extract content of 11.59 g/l and an ethanol content of 40% by volume is produced using 1.33 l of wine alcohol, and 1.84 l of the reserved portion of the wine. The extract content of the spirit was about 0.58 times the extract content of the original wine.

The yield relative to the wine used: 26.80%.

1. A spirit beverage produced exclusively from a wine, the spirit beverage containing 30-70% by volume of ethanol and having an extract content 0.5-3.5 times the extract content of the wine, the spirit beverage contains exclusively the components of the wine which is used for the production of said spirit beverage.

2. The spirit beverage of claim 1, wherein in the spirit beverage the original taste and aroma of the wine are retained.

3. A process for producing a spirit beverage that is produced exclusively from a wine and contains 30-70% by volume of ethanol, the process comprising:
a) subjecting the wine to a vacuum distillation to obtain a wine alcohol containing 35-85% by volume of ethanol,
b) continuing the vacuum distillation to result in wine water as a distillate that does not contain ethanol or contains a negligible amount of ethanol, and to obtain a wine concentrate as a distillation residue that does not contain ethanol or contains a negligible amount of ethanol,
wherein, in the course of the vacuum distillation according to steps a) and b), the temperature of the wine and the liquid that is formed therefrom during the vacuum distillation and which contains the extract content of the wine is maintained at 25° C. or below, and
wherein preferably a protective gas atmosphere is used for the vacuum distillation,
and wherein the wine alcohol according to step a) is optionally obtained by subjecting an alcoholic fraction obtained by a first vacuum distillation to a vacuum or atmospheric redistillation,
and
c) combining an amount of the wine alcohol with an amount of the wine concentrate and/or with an amount of the original wine and, optionally, with an amount of the wine water to obtain the spirit beverage, wherein the amount of the wine alcohol used and the amount of the wine concentrate optionally used and the amount of the wine water optionally used for the combination are obtained by the distillation of one or more batches of the original wine as carried out according to step a) and to the optionally performed step b).

4. The process according to claim 3, wherein the extract content of the spirit beverage is 0.5-3.5 times the extract content of the wine.

5. The process according to claim 3, wherein in the spirit beverage the original taste and aroma of the wine are retained.

6. The process according to claim 3, characterized in that steps a) and b) are carried out by an apparatus comprising an adjustable-temperature container for receiving the wine (1), a packed column (2), a unit for cooling the distillate (3), a collector for the distillate (4), a coolant container with a circulation pump (5), a container for the optionally used protective gas (6), and a vacuum pump (7).

7. The process according to claim 3, wherein the combining process comprises the use of the wine concentrate.

8. Use of a wine alcohol for producing a spirit beverage that has an ethanol content of 30-70% by volume and is made exclusively from wine, the wine alcohol containing 35-85% by volume of ethanol and being obtainable by a vacuum distillation of the wine, wherein, in the course of vacuum distillation, the temperature of the wine and the liquid that is formed therefrom during the vacuum distillation process and contains the extract content of the wine is maintained at 25° C. or below, and wherein preferably a protective gas atmosphere is used for the vacuum distillation.

9. A process for producing a spirit beverage that has an ethanol content of 30-70% by volume and is made exclusively from a wine, using a wine concentrate, comprising: obtaining the wine concentrate as the distillation residue of vacuum distillation of the wine, in the course of which the temperature of the wine and the liquid that is formed therefrom during the vacuum distillation and contains the extract content of the wine is maintained at 25° C. or below, and wherein preferably a protective gas atmosphere is used for the vacuum distillation.

10. Use of wine water for producing a spirit beverage that has an ethanol content of 30-70% by volume and is made exclusively from wine, the wine water being obtainable as an aqueous fraction of a fractional vacuum distillation of a wine, wherein the temperature of the wine and the liquid that is formed therefrom during the vacuum distillation process and contains the extract content of the wine is maintained at 25° C. or below, and wherein preferably a protective gas atmosphere is used for the vacuum distillation.

11. The process according to claim 9, wherein the extract content of the spirit beverage is 0.5-3.5 times the extract content of the wine.

12. The process according to claim 9, characterised in that vacuum distillation is carried out at a collector temperature of (−5)-(+3) ° C.

13. The process according to claim 9, wherein the wine is a grape wine, an apple wine, or a fruit wine.

14. The process according to claim 9, wherein the spirit beverage contains 38-55% by volume of ethanol, preferably 38-40% by volume of ethanol.

15. The process according to claim 3, characterised in that vacuum distillation is carried out at a collector temperature of (−5)-(+3) ° C.

16. The spirit beverage according to claim 1, wherein the wine is a grape wine, an apple wine, or a fruit wine.

17. The spirit beverage according to claim 1, wherein the spirit beverage contains 38-55% by volume of ethanol, preferably 38-40% by volume of ethanol.
